(19) United States
(12) Patent Application Publication
(10) Pub. No.: US 2014/0234498 A1
(43) Pub. Date: Aug. 21, 2014

(54) SHUTTER DEVICE AND METHOD FOR PRODUCING ENCRUSTED FOODS

(71) Applicants: Michio Morikawa, Tochigi (JP); Kazuhide Nanahara, Tochigi (JP); Yasunori Kondo, Tochigi (JP)

(72) Inventors: Michio Morikawa, Tochigi (JP); Kazuhide Nanahara, Tochigi (JP); Yasunori Kondo, Tochigi (JP)

(73) Assignee: RHEON AUTOMATIC MACHINERY CO., LTD.,, Tochigi (JP)

(21) Appl. No.: 14/117,509

(22) PCT Filed: May 31, 2012
(86) PCT No.: PCT/JP2012/064159

§ 371 Date: Nov. 13, 2013

(30) Foreign Application Priority Data
Jun. 2, 2011 (JP) 2011-124271
Jul. 26, 2011 (JP) 2011-163143
Mar. 30, 2012 (JP) 2012-079973

(51) Int. Cl. A21C 9/06; A21D 8/02

(52) U.S. Cl. CPC A21C 9/063; A21D 8/02
USPC 426/283; 425/112

(57) ABSTRACT

An encrusted food is produced by a shutter device comprising a plurality of shutter pieces respectively pivotally supported on a plurality of pivots arranged along a circle, each of which comprises a pressure face facing to a center of the circle, a linkage setting the shutter pieces in motion synchronously so as to direct the pressure faces toward the center, and rake faces respectively formed on the pressure faces to stand upward from lower edges of the pressure faces and so dimensioned as to scoop up a periphery portion of the dough when the motion of the shutter pieces brings the rake faces into contact with the periphery portion.

### TECHNICAL FIELD

The present invention relates to a shutter device or a production device including the shutter device for producing encrusted foods such as Chinese meat buns, and a method for producing the encrusted foods.

### BACKGROUND ART

Encrusted foods are foods in that any filling such as bean jam or minced meet is encrusted with dough such as bread dough or shortcrust. Chinese meat buns, filled cookies, filled doughnuts, and meat pies can be taken as examples of such encrusted foods.

Many encrusted foods are now produced in automated processes. The Patent Literature 1 discloses production devices and methods for encrusted foods. According to this art, a proper amount of filling is placed on dough that has been once rolled out into a flat shape, and peripheries of the dough are gathered by a shutter so that the filling is encrusted with and wrapped in the dough.

### CITATION LIST

### Patent Literature

[PTL 1]: Japanese Patent Application Laid-open No. 2008-259520

### DISCLOSURE OF INVENTION

As being understood from the above discussion, in an encrusted food automatically produced by the prior art, a top portion of a crust is made from gathered peripheries of dough. Even if the rolled dough before gathering has a uniform thickness, the gathered portion is built up to be thicker. The top portion of the crust, therefore, necessarily gets thicker than other portions of the crust. Top portions of crusts are sometimes, depending on types of encrusted foods, required to be even with or thinner than the other portions of the crusts. More specifically, some problems to be solved must be left in such production devices and production methods.

The present invention has been achieved in light of the aforementioned problems and is intended to provide a production device and a production method which enable reduction in size of a sealing portion projecting from a top portion of a crust of an encrusted food.

According to a first aspect of the present invention, a shutter device for encrusting filling placed at a center with dough, is comprised of: a plurality of shutter pieces arranged around the center so as to encircle the center, each of the shutter pieces having a pressure face facing to the center; a linkage setting the plurality of shutter pieces in motion synchronously so as to direct the pressure faces toward the center; and rake faces respectively formed on the pressure faces to stand upward from lower edges of the pressure faces and so dimensioned as to scoop up a periphery portion of the dough when the motion of the shutter pieces brings the rake faces into contact with the periphery portion.

According to a second aspect of the present invention, a production device applicable to production of an encrusted food in that filling is encrusted with dough, is comprised of: a flange having an opening into which the dough loaded with the filling is capable of sinking down, the flange being so structured as to support the dough; a conveyor configured to transport the dough onto the flange; a nozzle configured to expel the filling onto the dough on the flange; a plurality of shutter pieces disposed on the flange so as to be in contact with the flange and arranged around the center so as to encircle the center, each of the shutter pieces having a pressure face facing to the center; a linkage setting the plurality of shutter pieces in motion synchronously so as to direct the pressure faces toward the center; and rake faces respectively formed on the pressure faces to stand upward from lower edges of the pressure faces and so dimensioned as to scoop up a periphery portion of the dough when the motion of the shutter pieces brings the rake faces into contact with the periphery portion.

According to a third aspect of the present invention, a method for encrusting filling placed at a center with dough, is comprised of: arranging a plurality of shutter pieces around the center so as to encircle the center, each of the shutter pieces having a pressure face facing to the center; setting the plurality of shutter pieces in motion synchronously so as to direct the pressure faces toward the center by means of a linkage; bringing the pressure faces into contact with a periphery portion of the dough by means of the motion of the shutter pieces and scooping up a periphery portion of the dough by means of rake faces respectively formed on the pressure faces to stand upward from lower edges of the pressure faces; and pressing the periphery portion by the pressure faces toward the center with making the rake faces support the periphery portion.

According to a fourth aspect of the present invention, a production method applicable to production of an encrusted food in that filling is encrusted with dough, is comprised of: disposing a plurality of shutter pieces on a flange having an opening into which the dough loaded with the filling is capable of sinking down so as to be in contact with the flange; arranging the plurality of shutter pieces around the center of the flange so as to encircle the center, each of the shutter pieces having a pressure face facing to the center; transporting the dough onto the flange; setting the plurality of shutter pieces in motion synchronously so as to direct the pressure faces toward the center by means of a linkage; bringing the pressure faces into contact with a periphery portion of the dough by means of the motion of the shutter pieces and scooping up a periphery portion of the dough by means of rake faces respectively formed on the pressure faces to stand upward from lower edges of the pressure faces; expelling the filling onto the dough on the flange through a nozzle; making the dough loaded with the filling sink down into the opening; and pressing the periphery portion by the pressure faces toward the center with making the rake faces support the periphery portion.

### BRIEF DESCRIPTION OF DRAWINGS

FIG. 1 is a perspective view of a production device for an encrusted food according to an embodiment of the present invention.

FIG. 2A is a perspective view of a shutter piece according to the embodiment.

FIG. 2B is a perspective view of the shutter piece viewed from another point.

FIG. 2C is a perspective view of the shutter piece viewed from still another point.

FIG. 3A is a plan view showing shutter pieces along with a flange supporting dough.

FIG. 3B is an elevational sectional view showing the shutter pieces and the flange along with a nozzle for expelling filling, which shows a state where a finished encrusted food is being taken out and a new piece of dough has been transported just above the flange.

FIG. 4A is a plan view showing the shutter pieces along with the flange, which shows a state where the dough is placed on the flange.

FIG. 4B is an elevational sectional view of the shutter pieces, the flange and the nozzle, which shows a state where the dough is placed on the flange.

FIG. 5A is a plan view showing the shutter pieces along with the flange, which shows a state where the shutter pieces have swung toward the center until they have gotten in contact with a periphery portion of the dough.

FIG. 5B is an elevational sectional view of the shutter pieces, the flange and the nozzle, which shows a state where the shutter pieces have swung toward the center until they have gotten in contact with a periphery portion of the dough.

FIG. 6A is a plan view showing the shutter pieces along with the flange, which shows a state where the shutters and the flange get elevated toward the nozzle.

FIG. 6B is an elevational sectional view showing the shutter pieces along with the flange, which shows a state where the shutters and the flange get elevated toward the nozzle.

FIG. 7A is a plan view showing the shutter pieces along with the flange, which shows a state where the filling is placed on the dough.

FIG. 7B is an elevational sectional view of the shutter pieces, the flange and the nozzle, which shows a state where the filling is being expelled through the nozzle onto the dough.

FIG. 8A is a plan view showing the shutter pieces along with the flange, which shows a state where the dough loaded with the filling sinks down into the opening.

FIG. 8B is an elevational sectional view of the shutter pieces, the flange and the nozzle, which shows a state where a valve member comes down so as to stuff the filling into the dough.

FIG. 9A is a plan view showing the shutter pieces along with the flange, which shows a state where the dough loaded with the filling sinks down into the opening.

FIG. 9B is an elevational sectional view of the shutter pieces, the flange and the nozzle, which shows a state where the shutters and the flange come down and the nozzle is detached from the filling.

FIG. 10A is a plan view showing the shutter pieces along with the flange, which shows a state where the shutter pieces have further swung toward the center.

FIG. 10B is an elevational sectional view of the shutter pieces, the flange and the nozzle, which shows a state where the shutter pieces have further swung toward the center.

FIG. 11A is a plan view showing the shutter pieces along with the flange, which shows a state where the periphery portion of the dough is gathered by the shutter pieces.

FIG. 11B is an elevational sectional view of the shutter pieces, the flange and the nozzle, which shows a state where the periphery portion of the dough is gathered by the shutter pieces.

FIG. 12A is a plan view that should be compared with FIG. 9A, which shows the dough loaded with the filling sinks down into the opening.

FIG. 12B is an elevational sectional view that should be compared with FIG. 9B, which shows a state where the shutters and the flange come down to detach the nozzle from the filling and the valve member simultaneously gets elevated.

FIG. 13 is a plan view of a production device for encrusted foods according to the embodiment.

FIG. 14A is a plan view showing shutter pieces along with a flange of a production device of the other embodiment.

FIG. 14B is an elevational sectional view showing the shutter pieces and the flange along with a nozzle for expelling filling according to the embodiment, which shows a state where a finished encrusted food is being taken out and a new piece of dough has been transported just above the flange.

FIG. 15 is an elevational sectional view of the shutter pieces, the flange and the nozzle, which shows a state where the dough is placed on the flange.

FIG. 16 is an elevational sectional view of the shutter pieces, the flange and the nozzle, which shows a state where the shutter pieces have swung toward the center until they have gotten in contact with a periphery portion of the dough.

FIG. 17 is an elevational sectional view of the shutter pieces, the flange and the nozzle, which shows a state where the shutters and the flange get elevated toward the nozzle.

FIG. 18A is a plan view showing the shutter pieces along with the flange, which shows a state where the filling is placed on the dough.

FIG. 18B is an elevational sectional view of the shutter pieces, the flange and the nozzle, which shows a state where the filling is being expelled through the nozzle onto the dough.

FIG. 19A is a plan view showing the shutter pieces along with the flange, which shows a state where the dough loaded with the filling sinks down into the opening.

FIG. 19B is an elevational sectional view of the shutter pieces, the flange and the nozzle, which shows a state where a valve member comes down so as to stuff the filling into the dough.

FIG. 20A is a plan view showing the shutter pieces along with the flange, which shows a state where the dough loaded with the filling sinks down into the opening.

FIG. 20B is an elevational sectional view of the shutter pieces, the flange and the nozzle, which shows a state where the valve member comes down and the shutter and the flange come down so that the nozzle is detached from the filling.

FIG. 21A is a plan view showing the shutter pieces along with the flange, which shows a state where the shutter pieces have further swung toward the center.

FIG. 21B is an elevational sectional view of the shutter pieces, the flange and the nozzle, which shows a state where the shutter pieces have further swung toward the center.

FIG. 22A is a plan view showing the shutter pieces along with the flange, which shows a state where the periphery portion of the dough is gathered by the shutter pieces.

FIG. 22B is an elevational sectional view of the shutter pieces, the flange and the nozzle, which shows a state where the periphery portion of the dough is gathered by the shutter pieces.

FIG. 23 is an elevational sectional view of the nozzle, which should be compared with FIG. 17.

FIG. 24A is a perspective view of a shutter piece according to a modified example.

FIG. 24B is a perspective view of the shutter piece viewed from another point.

FIG. 24C is a perspective view of a plurality of shutter pieces fitting with each other.

FIG. 25 is a plan view showing an example in that linear motion makes the shutter pieces move toward the center.

FIG. 26 is a plan view of a plurality of shutter pieced according to another modified example.

FIG. 27 is a plan view showing a state where a ring with a driving shaft is made to fit in slots of the shutter pieces.

FIG. 28 is a plan view of shutter pieces and a ring according to the other modified embodiment, which should be compared with FIG. 17.

FIG. 29 is a plan view showing an example of a cam mechanism for driving the shutter pieces.

### BEST MODE FOR CARRYING OUT THE INVENTION

Exemplary embodiments of the present invention will be described hereinafter with reference to the appended drawings.

A production device 1 is applicable to production of encrusted foods in that filling is encrusted with dough.

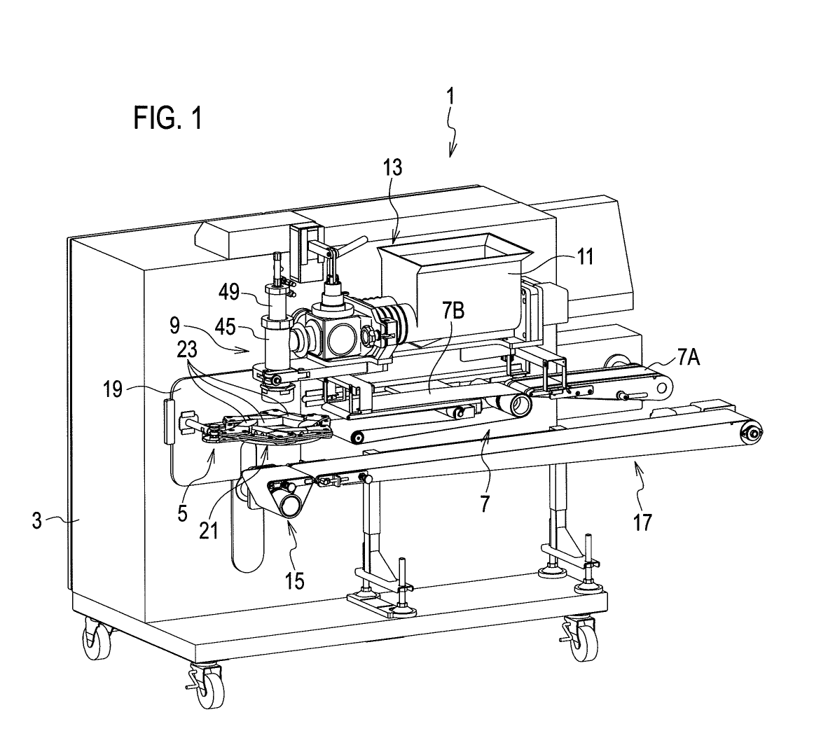

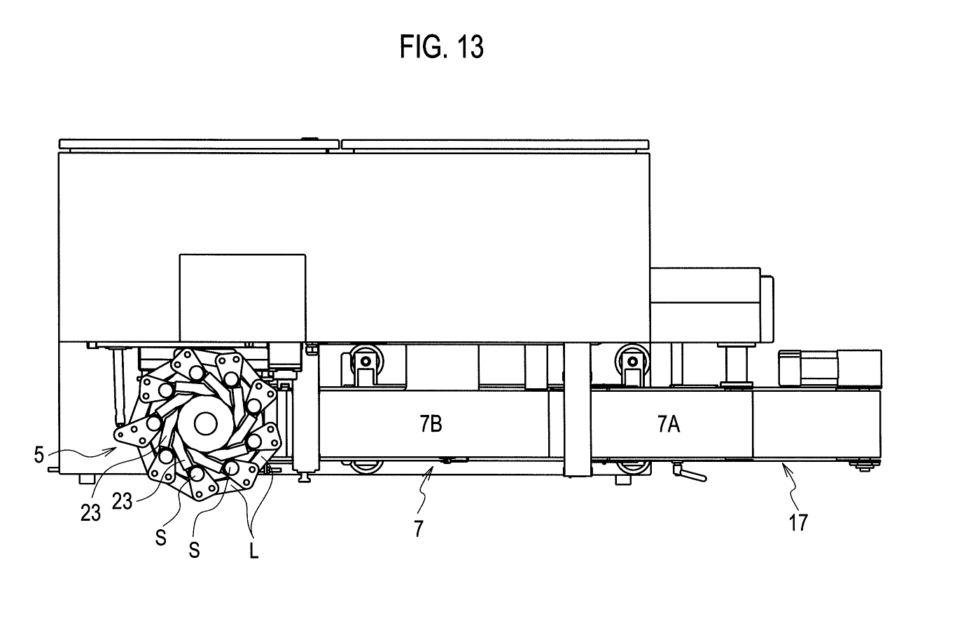

Referring to FIGS. 1, 13, the production device 1 is preferably comprised of a frame 3 and the following elements contained in the production device 1 are generally secured to, or movably supported by, the frame 3. The production device is comprised of a shutter device 5, a conveyor 7 for transporting dough, a nozzle 9 for expelling filling onto the dough, a supporting device 15 for receiving encrusted foods, and a carrier 17 for carrying the encrusted foods out.

The shutter device 5 is supported by an elevator member 19 capable of going up and down as being driven by a proper actuator device, thereby being capable of going up and down. For the purpose of driving up and down, any known actuator means such as a hydraulic cylinder is applicable.

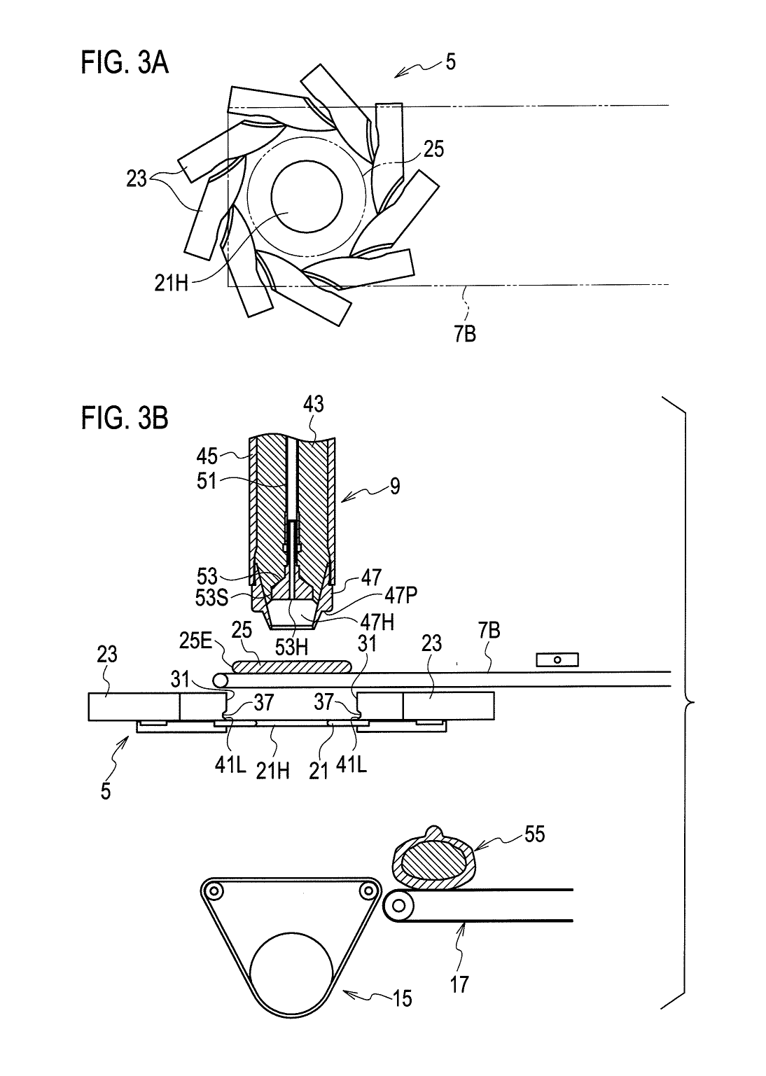

Referring to FIGS. 3A and 3B in combination with FIGS. 1, 13, the shutter device 5 is comprised of a flange 21 for supporting dough 25, and a plurality of shutter pieces 23 arranged around its center so as to encircle the center.

On the flange 21, an opening 21H is opened at the center thereof and has a diameter so adapted that the dough 25 loaded with filling 29 sinks down into the opening 21H. The opening 21H is preferably circular and is still preferably coaxial with a circumference along which the shutter pieces 23 are arranged.

The plurality of shutter pieces 23 is movably disposed on, and is in contact with, the flange 21. As being arranged so as to encircle the center as described above, the shutter pieces 23 define a substantially circular region and can make motion toward its center to narrow this encircled region. When in motion, the shutter pieces 23 keep in contact with and slide along the flange 21. More specifically, the shutter pieces 23, as making such motion, gather peripheries of the dough 25 placed on the flange 21 toward the center.

To make the shutter pieces 23 be movable, any proper structure is applied thereto. In an example shown in FIG. 3A for instance provided is a plurality of pivots arranged along a circle around the center, by which the shutter pieces 23 are respectively pivotally supported. More specifically, the shutter pieces 23 respectively swing around the pivots so that the encircled region is narrowed.

The number of the shutter pieces 23 can be properly selected in light of the purpose of gathering the peripheries of the dough 25 and can be, for example, set to be three or more. In most of the appended drawings, the number of the shutter pieces 23 is nine but this number is no more than a convenience of explanation.

To set the plurality of shutter pieces 23 in motion synchronously, any proper linkage is applicable thereto. As shown in FIG. 13 for example, links L are applicable, by which the pivots S of the shutter pieces 23 are mutually linked. When rotating the links L, the plurality of shutter pieces 23 synchronously swings. When the links L clockwise rotate in the example shown in the drawings for instance, the plurality of shutter pieces 23 swings toward the center (then the encircled region is narrowed). Any proper actuator means such as a pneumatic or hydraulic cylinder, a servomotor or a linear motor is applicable for the purpose of controllably driving the linkage.

Instead of the links L mutually linking the pivots S, a polygonal frame connected with the plurality of pivots S is applicable. Alternatively any other linkages are also applicable and some of them will be illustrated later. Still alternatively, instead of the linkage, applicable is any proper structure such as a combination of the respective pivots S and actuator means such as servomotors respectively coupled with the pivots S.

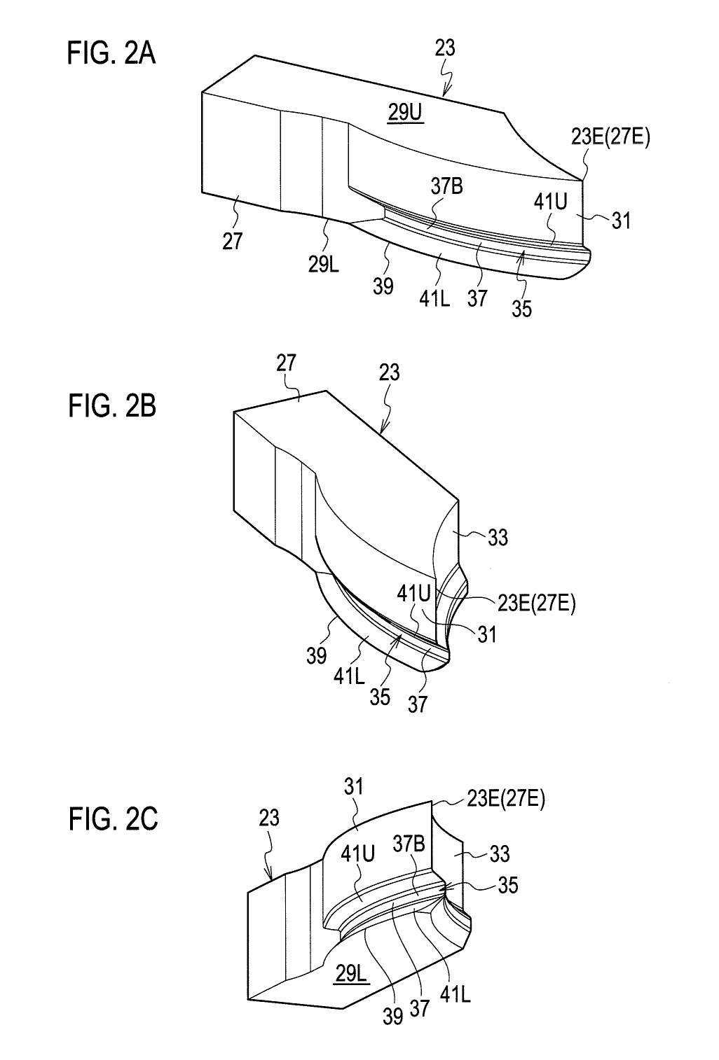

Referring to FIGS. 2A through 2C, each shutter piece 23 is comprised of a main body 27 of a quadrangular prism shape. An upper face 29U and a lower face 29L of the main body 27 are horizontal and the other faces are in general vertical.

Close to a tip end of the main body 27 provided is a pressure face 31 facing to the center of the aforementioned circumference, which is a curved face bulging out toward the center of the circumference. The pressure face 31 is adapted for pressing the dough 25. Further, opposite to the pressure face 31 provided is a relief face 33 for sliding on a pressure face 31 of an adjacent shutter piece 23. The pressure face 31 and the relief face 33 meet at the tip end 27E of the main body 27 (namely, the tip end 23E of the shutter piece 23).

Close to a lower edge of the pressure face 31, and ranging from the tip end 23E to a proximal end of the pressure face 31, provided is a structure 35 for supporting a periphery portion 25E of the dough 25. The supporting structure 35 is comprised of a rake face 41L standing upward from the lower edge of the pressure face 31. The rake face 41L is an oblique face with a proper rake angle away from the lower face 29L to form an edge, and the rake angle is for example beyond 0 degrees but less than 90 degrees. The rake face 41L, when the shutter piece 23 swings to bring the pressure face 31 into contact with the periphery portion 25E of the dough 25, gets under and scoops up the periphery portion 25E, thereby supporting the periphery portion 25E. To prevent the edge from unintentionally cutting the dough 25, the edge may be properly rounded.

The supporting structure 35 may be additionally comprised of an overhang face 41U opposed to the rake face 41L so that the rake face 41L and the overhang face 41U constitute a groove 37. The groove 37 may be further comprised of a bottom face 37B that is substantially vertical. The groove 37 may preferably have a proper width in light of the thickness of the periphery portion 25E of the dough 25 so that the scooped periphery portion 25E is caught in and supported by the groove 37.

Alternatively, instead of or in addition to the groove, any structure such as a proper hollow, a projection, a step, or any combination thereof, adapted for adhering to and supporting the periphery portion 25E can be used.

The relief face 33 is properly formed to be a concave curved surface so as to slide on the pressure face 31 of the adjacent shutter piece 23 when the shutter piece 23 swings. Further, if the adjacent shutter piece 23 has the groove 37, the relief face 33 may have a rib slidably fitting thereto.

When one shutter piece 23 swings, the pressure face 31 and the relief face 33 slide on each other and thereby the adjacent shutter piece 23 synchronously swings, thereby all the shutter pieces 23 synchronously swing. While it has been explained in the aforementioned description that the links L connect all the shutter pieces 23, it may be modified so that any of the shutter pieces 23 is connected thereto and respective sliding motions render synchronous motion of all the shutter pieces 23. This structure by which the series of mutual sliding motion sets the whole into synchronous motion is a kind of the aforementioned linkage.

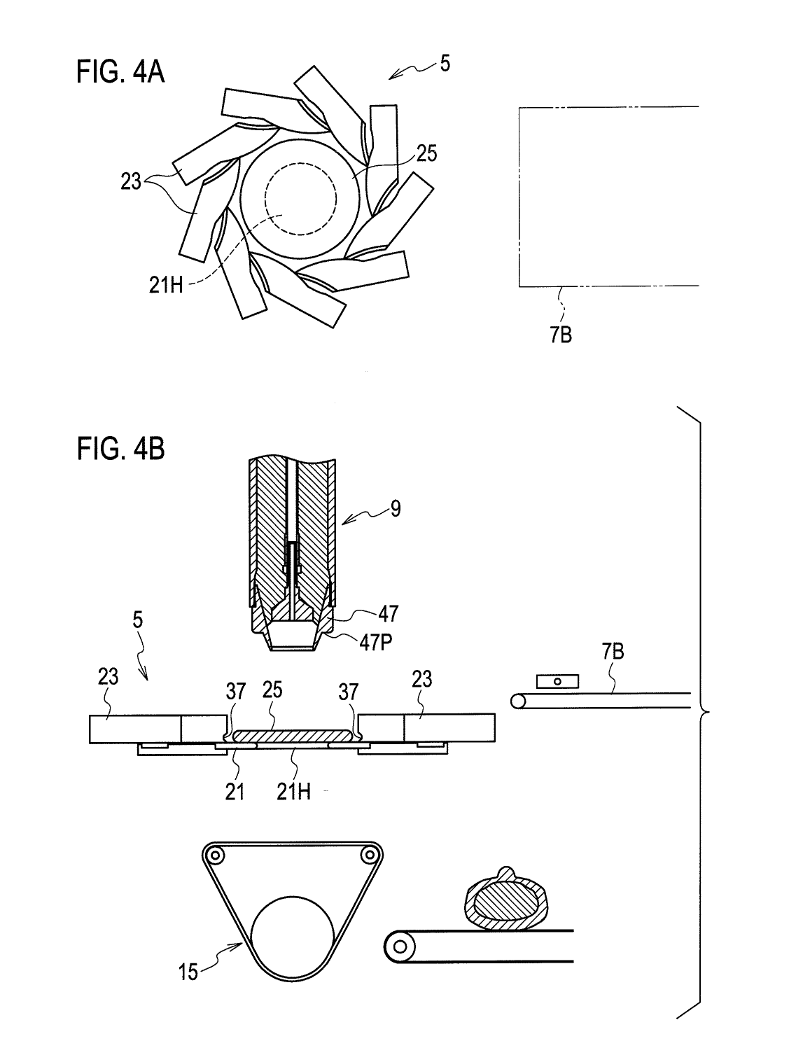

To the conveyor 7 applicable is a known conveyance means. In an example shown in FIGS. 1, 13 for instance, a first belt conveyor 7A and a second belt conveyor 7B are applied. Plural pieces of dough 25 respectively rolled out into a flat shape are laid on the first belt conveyor 7A and are one by one transported to the second belt conveyor 7B. The end of the second belt conveyor 7B is so structured as to be controllably extendable from a stand-by position shown in FIG. 4 to an advanced position shown in FIG. 3 for instance. The second belt conveyor 7B can therefore transport the dough 25 transported from the first conveyor 7A onto the flange 21 (in the region encircled by the plurality of shutter pieces 23 and just under the nozzle 9) under control, and, on the other hand, does not disturb operation of the nozzle 9 and the shutter device 5 by moving backward. Of course instead of the belt conveyors, robot arms, levitation devices, or any known conveyor means may be applied thereto.

Referring back to FIGS. 1, 13, to the nozzle 9 connected is a feeder device 13 comprised of a hopper 11. The feeder device 13, for example, has a rotary pump or such built therein, so as to fill the nozzle 9 with the filling 43 fed from the hopper 11 under controlled pressure. Alternatively instead of, or in addition to, the rotary pump, any proper pressurizing means such as a pneumatic cylinder can be used. While the nozzle 9 is secured to the frame 3, it may be alternatively made vertically movable.

Referring to FIG. 3B for example, the nozzle 9 is comprised of a main body 45 generally of a hollow cylinder, a nozzle member 47 having an opening at its tip end, and a valve member 53 for closing the opening of the nozzle member 47. The filling 43 fed by the feeder device 13 is first filled within the hollow in the main body 45 and stands by for expulsion there.

The nozzle member 47 fits in the tip end of the main body 45. Its internal hollow 47H is in spatial communication with the internal hollow of the main body 45 and tapers toward the opening at its tip end.

The valve member 53 is supported by a plunger 51 passing through the hollow of the main body 45 and is comprised of a disk 53S widened at its lowermost end. The plunger 51 is connected with an actuator 49 driven by hydraulic or pneumatic pressure at its upper end, and is made by the actuator 49 to move up and down.

As the valve member 53 is pressed down by the plunger 51, the disk 53S comes into close fit with the nozzle member at any position of the tapered hollow 47H. More specifically, whether the nozzle 9 is opened or closed is controlled by whether the valve member 53 goes up or down. Or, depending on viscosity or a grain size of the filling 43, closure of the nozzle 9 may occur without close fit. Preferably the diameter of the disk 53S is regulated so that the nozzle 9 is substantially closed at least when a lower face of the disk 53S becomes flush with the opening of the nozzle member 47.

The disk 53S is preferably, in order to prevent adhesion of the filling 43, made of any proper material such as any fluoropolymer, and its lower face 53L can be a horizontal flat face. Further to prevent adhesion of the filling 43, it is advantageous to reduce area of the lower face 53L, and it may be processed with a proper surface treatment.

Preferably the valve member 53 is comprised of a through hole 53H in spatial communication with the interior of the plunger 51. Further the plunger 51 is connected with an air source such as a compressor provided outside.

The nozzle member 47 is preferably comprised of a shoulder portion 47P for catching the dough 25 between a rim portion of the opening 21H of the flange 21 and the shoulder 47P. The shoulder portion 47P may be alternatively so dimensioned as to catch the dough 25 between the pressure faces 31 of the shutter pieces 23 and the shoulder portion 47P.

The supporting device 15 is vertically movable independently from the shutter device 5. Any known actuator means such as a pneumatic cylinder or a hydraulic cylinder is applicable for the purpose of upward and downward actuation. The supporting device 15 has a proper structure for gently receiving the dough 25 loaded with the filling 43. The supporting device 15 is for example an elastic body forming a closed loop as shown in FIG. 3B, and may be so constructed as to carry encrusted foods 55 out to the carrier 17 by means of operation of rollers.

To the carrier 17 applicable is any known transporting means such as a belt conveyor, a robot arm, or a levitation device. By means of the carrier 17, completed encrusted foods 55 are taken out of the device.

Referring mainly to FIG. 3A through FIG. 12B, encrusted foods 55 are produced in a way as described below. In the meantime, a plurality of encrusted foods 55 are sequentially and continuously produced by repeating the following steps and therefore it should not be understood that any of the steps described below is an initial or final step.

Referring to FIG. 3A for example, the plurality of shutter pieces 23 is at an instant directed outward (the encircled region is widened), the second belt conveyor 7B is at an advanced position, and the dough 25 thereon is positioned just above the flange 21. Referring to FIG. 3B, the supporting device 15 is at a lowered position and an encrusted food 55 completed in advance has been transferred to the carrier 17.

The second belt conveyor 7B is next made to go back and then the dough 25 falls down onto the flange 21 as shown in FIGS. 4A, 4B. Then the supporting device 15 is elevated in preparation for supporting the dough 25.

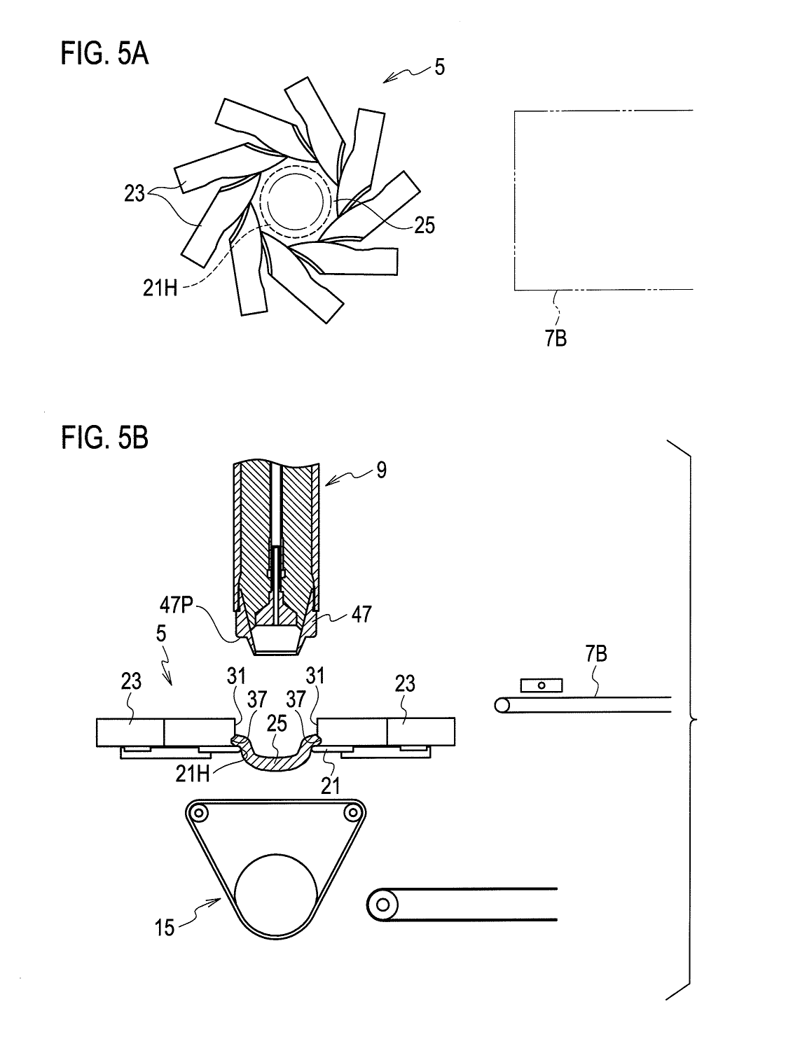

Next as shown in FIG. 5A, as the plurality of shutter pieces 23 is made to synchronously swing toward the center (the encircled region is narrowed), the pressure faces 31 of the shutter pieces 23 as shown in FIG. 5B get in contact with the periphery portion 25E of the dough 25 and the rake faces 41L get under and scoop up the periphery portion 25E, thereby supporting the periphery portion 25E. In connection with the swing motion, the scooped periphery portion 25E is pressed into and caught by the grooves 37 and therefore the periphery portion 25E is further firmly supported by the supporting structure 35.

Further, pressure applied by the pressure faces 31 makes the center of the dough 25 match with the center of the opening 21H. Then as its own weight acts thereon, the center and its surroundings of the dough 25 sink down into the opening 21H.

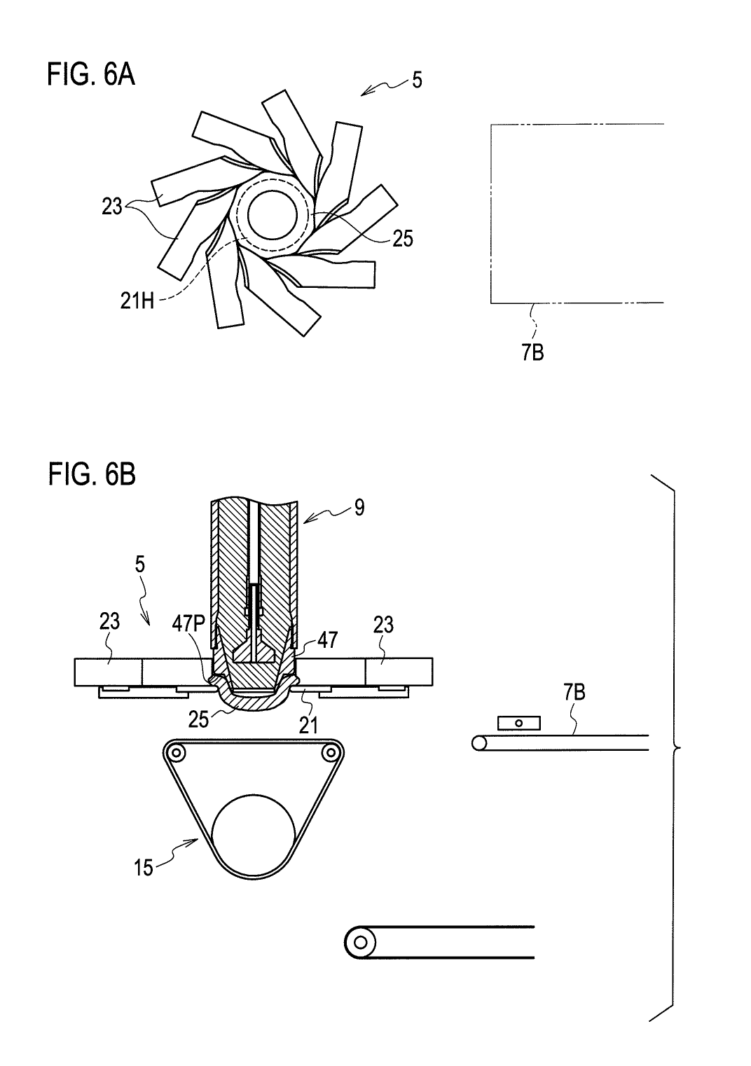

The plurality of shutter pieces 23 is further made to swing toward the center and the circle encircled by the pressure faces 31 as shown in FIG. 6A substantially matches with an outline of the shoulder portion 47P of the nozzle member 47. The shutter pieces 23 halt there.

As the shutter device 5 and the supporting device 15 are further elevated, the nozzle member 47 gets in contact with the dough 25 as shown in FIG. 6B. Then the periphery portion 25E is caught between the shoulder portion 47P and the rim of the opening 21H of the flange 21, or between the shoulder portion 47P and the pressure faces 31 of the shutter pieces 23, thereby the periphery portion 25E is more firmly supported. The instant when the circle encircled by the pressure faces 31 matches with the outline of the shoulder portion 47P of the nozzle member 47 and the instant when the dough 25 is caught by the shoulder portion 47P may be simultaneous but there may be a time lag therebetween.

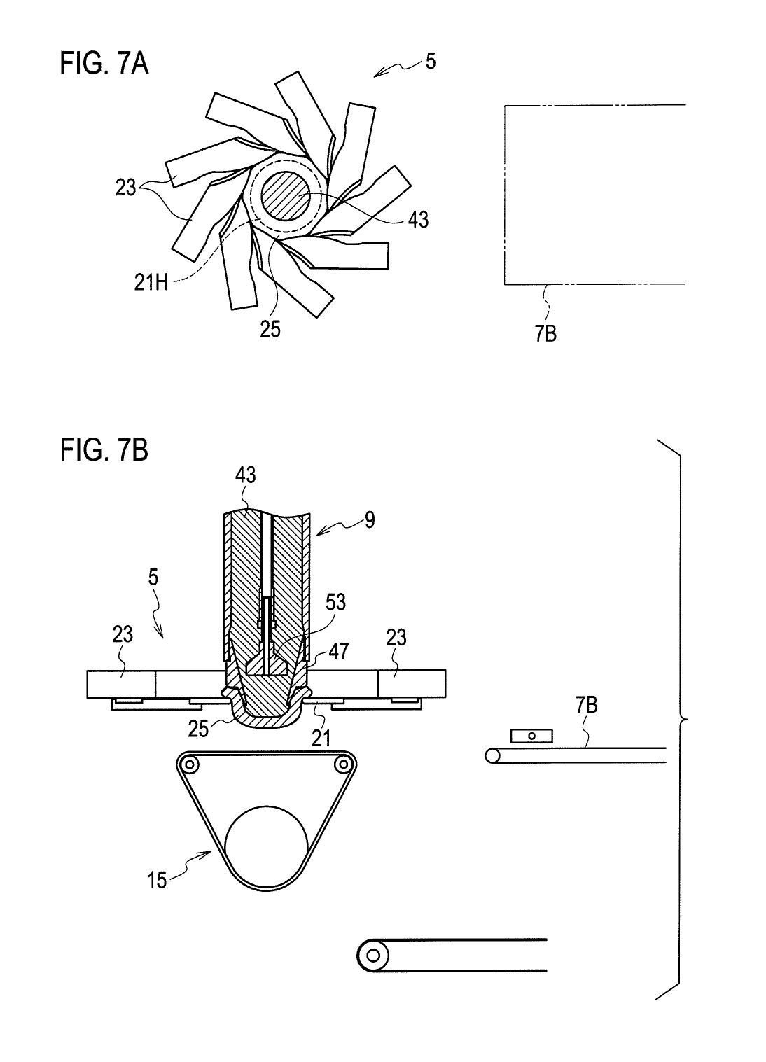

Further referring to FIGS. 7A, 7B, the plunger 51 sets the valve member 53 at an elevated position, and the filling 43 is given pressure by the feeder device 13 and is thereby expelled onto the dough 25. The amount of the filling 43 is properly regulated by means of the feeder device 13. The supporting device 15 then, as described above, gets elevated to a position adapted for supporting the dough 25.

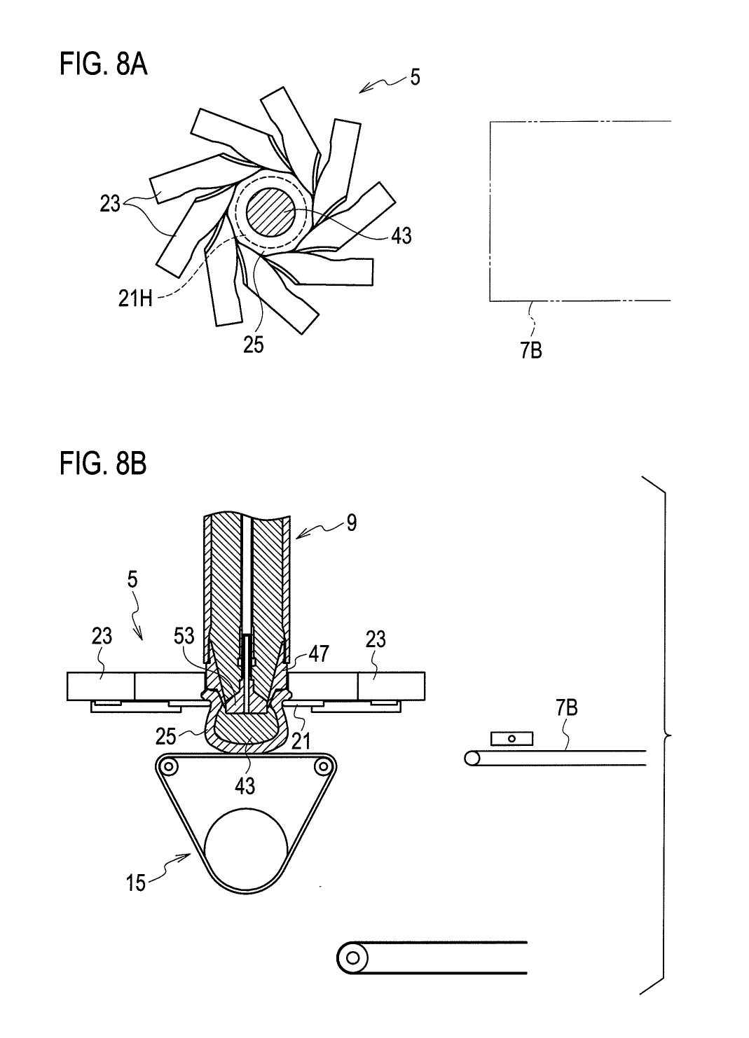

Further referring to FIGS. 8A, 8B, the filling 43 is expelled out and its weight makes the dough 25 further bulge downward. Then the dough 25 loaded with the filling 43 is supported from its lower side by the supporting device 15. The plunger 51 next lets the valve member 53 down, thereby stuffing the dough 25 with a controlled amount of filling 43. The height of an upper face 43U of the filling 43 is then defined by a lower face of the valve member 53.

In this process, as the lower face of the dough 25 is supported by the supporting device 15, the part at issue hardly extends and therefore keeps its original thickness. As being stuffed with the filling 43, the dough 25 bulges radially. Thus mainly a portion ranging from its side to the periphery portion 25E is drawn out and made slightly thinner. Alternatively, during this process, the supporting device 15 may be made to gradually go down so as to regulate the degree of radial bulging.

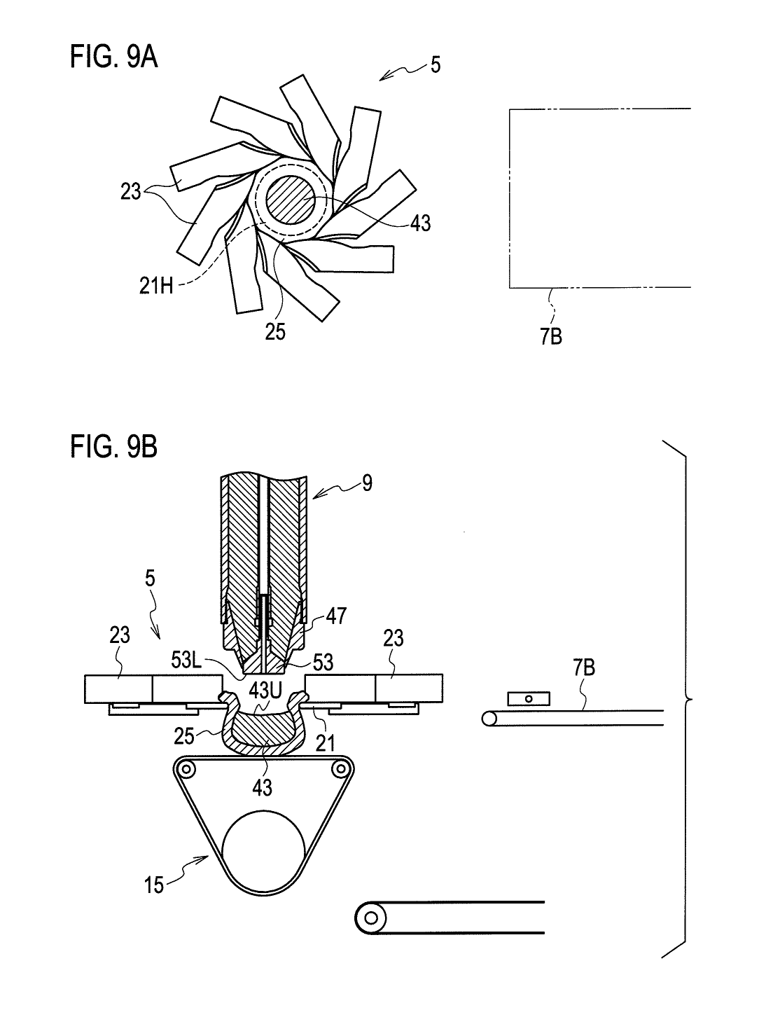

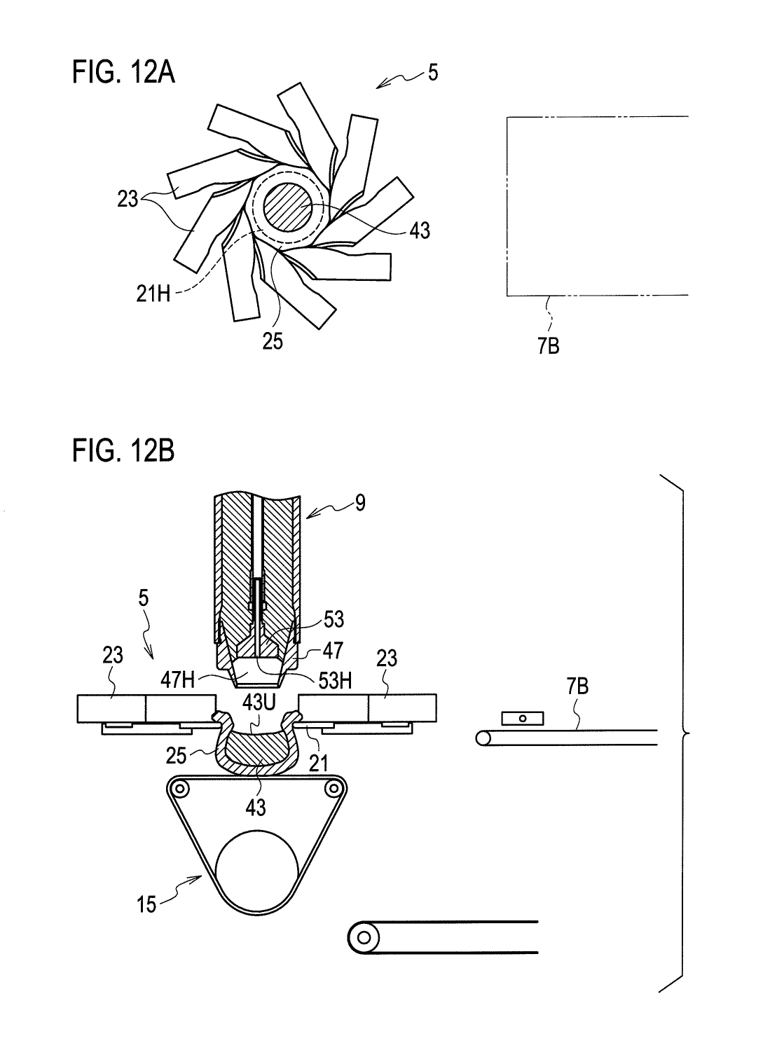

Referring to FIGS. 9A, 9B, the shutter device 5 and the supporting device 15 are made to go down together. Therefore the nozzle member 47 is detached from the filling 43 on the dough 25. The valve member 53 may be then elevated as shown in FIGS. 12A, 12B. If doing so, inertial force acts on the filling 43 and on the other hand the valve member 53 gets elevated, thereby promoting separation of the filling 43 from the valve member 53. Shearing motion of the valve member 53 relative to the nozzle member 47 also promotes separation of the filling 43. Further it may be executed to inject air through the through hole 53H. These actions are advantageous in preventing adhesion of the filling 43 to the valve member 53.

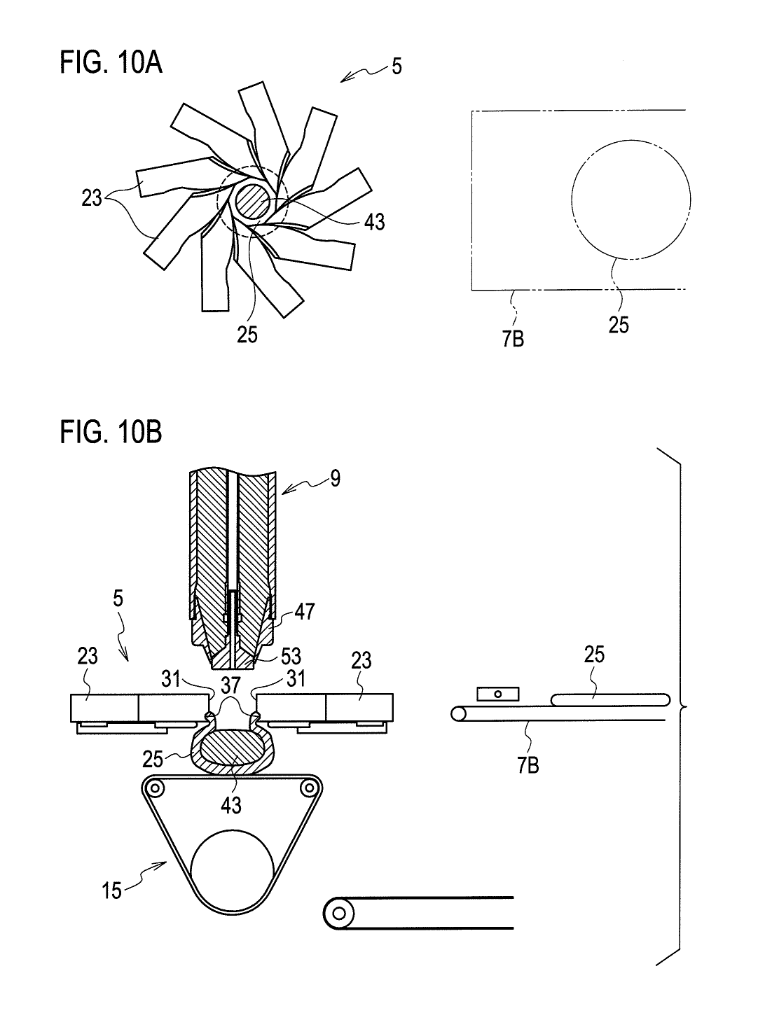

The plurality of shutter pieces 23 has so far kept the state shown in FIGS. 6A, 6B and is now made to synchronously swing toward the center (the encircled region is narrowed) again as shown in FIGS. 10A, 10B. The periphery portion 25E of the dough 25 supported by the supporting structure 35 is further drawn out and gathered toward the center.

The height of the upper face 43U of the filling 43 has been in advance defined by the lower face of the valve member 53 and is lower than that of the periphery portion 25E of the dough 25 during gathering. Thus there is no concern that the filling 43 spills out during this process. Preferably the shutter device 5 and the supporting device 15 keep to go down.

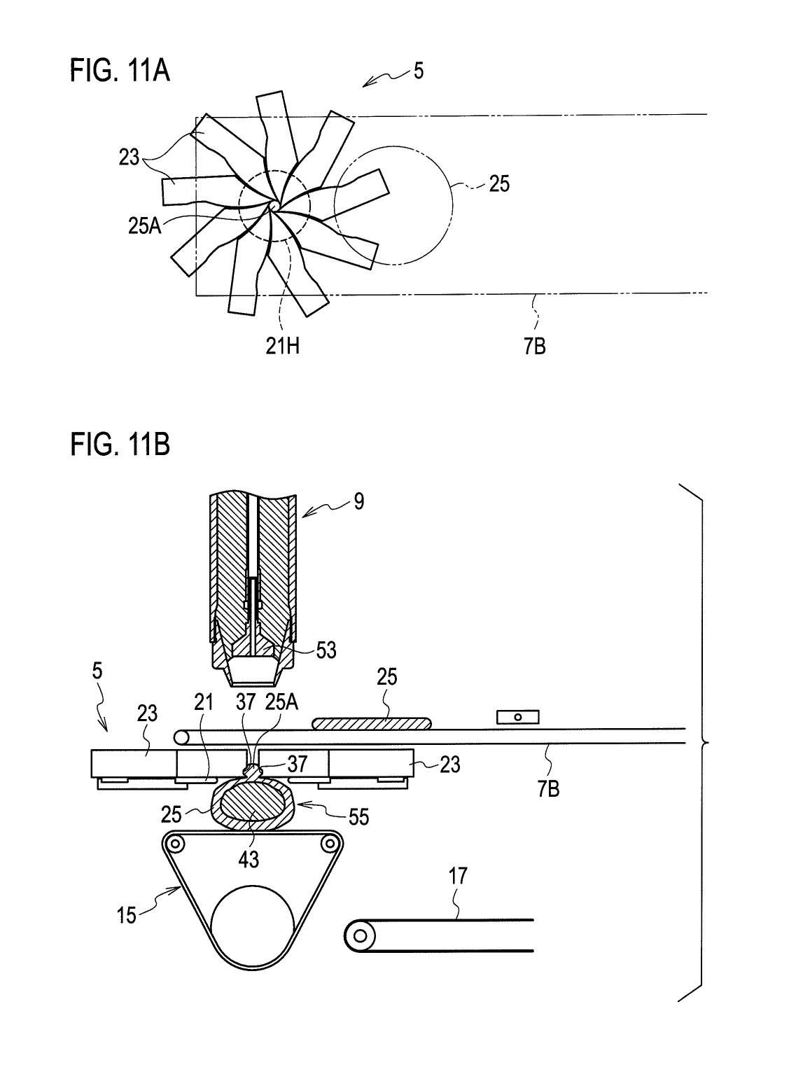

By further making the shutter pieces 23 swing, the periphery portion 25E of the dough 25 is thoroughly gathered as shown in FIGS. 11A, 11B, and is press-bonded at the sealing portion 25A. The filling 43 is in this way covered with the dough 25 and then an encrusted food 55 is finished up. Then the second conveyor 7B is driven to transport next dough 25 onto the flange 21.

The shutter pieces 23 are made to swing in reverse directions to release the dough 25 and the supporting device 15 loaded with the encrusted food 55 further goes down. The supporting device 15 transfers the encrusted food 55 to the carrier 17 and the encrusted food 55 is carried out by the carrier 17. In parallel, a next piece of dough 25 reaches the flange 21 and thus the state returns to that shown in FIGS. 3A, 3B.

Meanwhile, while the aforementioned description has stated that the supporting device 15 stays at a position where the device 15 immediately supports the dough 25 bulging downward, the supporting device 15 may stay more distant therefrom. The device 15 may be at any place where it prevents the dough 25 from falling off.

As being understood from the above description, the periphery portion 25E of the dough 25 gets into the supporting structure 35 and is thereby supported. The dough 25 simultaneously bulges out and is gathered. Therefore portions closer to the periphery portion 25E tend to extend greater. The periphery portion 25E of itself is reduced in thickness by being pinched. As being gathered after thickness reduction, the upper portion of the crust does not come to be thick, and may be rather made thinner. Further the original size of the dough 25 can be in advance reduced in prospect of subsequent extension. This is advantageous in light of economy of foodstuffs.

On the top of the encrusted food 55, as with the prior art, a sealing portion 25A slightly projecting upward is formed. Because the height of the sealing portion in the prior art originates from the thickness of the shutter, the sealing portion necessarily grows relatively large. In contrast in the present embodiment, the sealing portion 25A merely originates from the width of the supporting structure 35 and therefore the sealing portion 25A comes to be relatively small. This is advantageous in view of aesthetic quality and economy of foodstuffs.

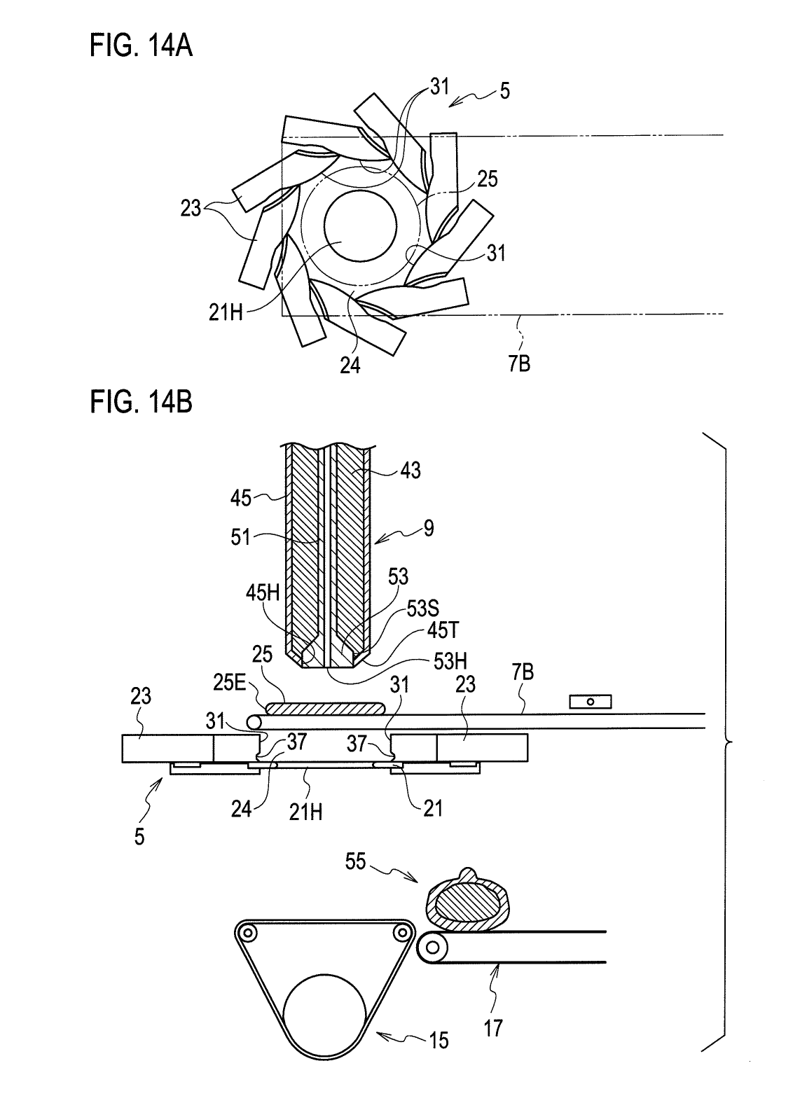

Various modifications to the aforementioned embodiment will occur. For example, as illustrated in FIGS. 14A through 23, in the nozzle 9, the nozzle member 47 may be formed in a unitary body with the main body 45. The tip end of the nozzle 9, as with the above, tapers toward the opening 45H.

Further, the valve member 53 may be formed in a unitary body with the plunger 51. A valve portion 53 widened at a lowermost end of a plunger portion 51 is formed in a unitary body and functions as a valve body. The lowermost end of the valve portion 53 is a disk portion 53S. As with the above, the plunger portion 51 is connected to the actuator 49 and is thereby made to go up and down.

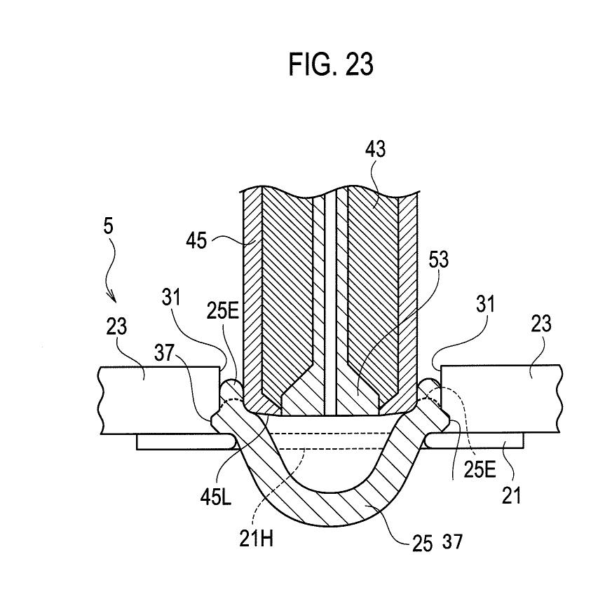

The main body 45 of the nozzle 9 is preferably comprised of a shoulder portion 45T for catching the dough 25 between the rim of the opening 21H of the flange 21 and the shoulder portion 45T. The shoulder portion 45T may be alternatively so dimensioned as to catch the dough 25 between the pressure faces 31 of the shutter pieces 23 and the shoulder portion 45T. The shoulder portion 45T may be, as shown in FIGS. 14 through 22, a tapering shape that tapers down toward the lower end. This is advantageous in pressing the periphery portion 25E outward to ensure support thereof. Alternatively any proper shape adapted for pressing the periphery portion 25E outward is applicable. Still alternatively, the shoulder portion 45L may be, as shown in FIG. 23, a flat lower end.

The other elements may be either similar to those of the aforementioned embodiment or properly modified.

Encrusted foods 55 are produced in a similar way also by these modified embodiments.

More specifically, referring to FIG. 14A for instance, the plurality of shutter pieces 23 is at an instant directed outward (the encircled region is widened), the second belt conveyor 7B is at an advanced position, and the dough 25 thereon is positioned above the flange 21. Referring to FIG. 14B, the supporting device 15 is at a lowered position and an encrusted food 55 completed in advance has been transferred to the carrier 17.

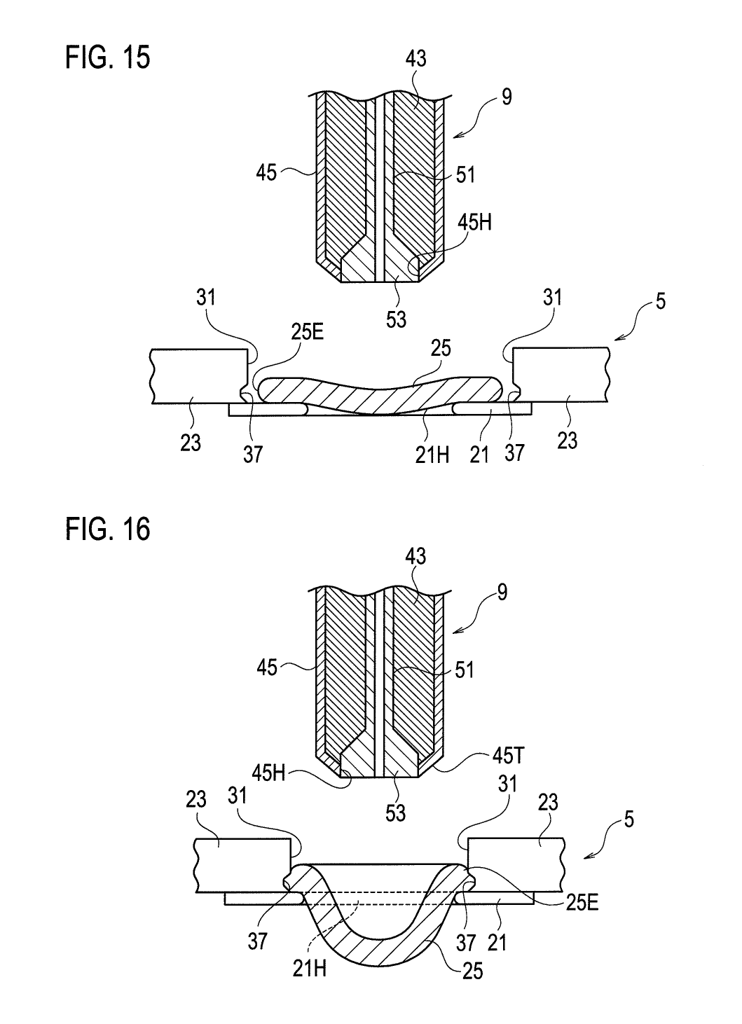

The second belt conveyor 7B is next made to go back and then the dough 25 falls down onto the flange 21 as shown in FIG. 15. Then the supporting device 15 is elevated in preparation for supporting the dough 25.

Next as shown in FIG. 16, as the plurality of shutter pieces 23 is made to synchronously swing toward the center (the encircled region is narrowed), the pressure faces 31 of the shutter pieces 23 get in contact with the periphery portion 25E of the dough 25 and the rake faces get under and scoop up the periphery portion 25E, thereby supporting the periphery portion 25E. In connection with the swing motion, the scooped periphery portion 25E is pressed into and caught by the grooves 37 and therefore the periphery portion 25E is further firmly supported by the supporting structure 35.

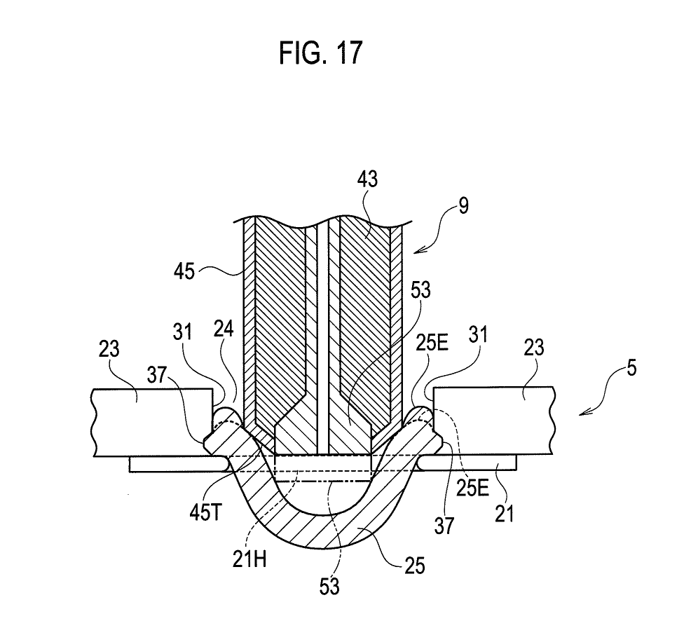

Further referring to FIG. 17, the plurality of shutter pieces 23 is further made to swing toward the center, the shutter device 5 and the supporting device 15 are further elevated, and then the shoulder portion 45T of the nozzle 9 gets in contact with the dough 25. Then the periphery portion 25E is caught between the shoulder portion 45T and the rim of the opening 21H of the flange 21, or between the shoulder portion 45T and the pressure faces 31 of the shutter pieces 23, thereby the periphery portion 25E is more firmly supported.

Because the shoulder portion 45T has a shape adapted for pressing the periphery portion 25E outward, the periphery portion 25E is pressed into the supporting structure 35, thereby support by the supporting structure 35 is further ensured. Further as illustrated in FIGS. 17, 23, a portion of the periphery portion 25E is pushed up into the gap between the pressure faces 31 and the nozzle main body 45. This is advantageous in forming thinner crusts.

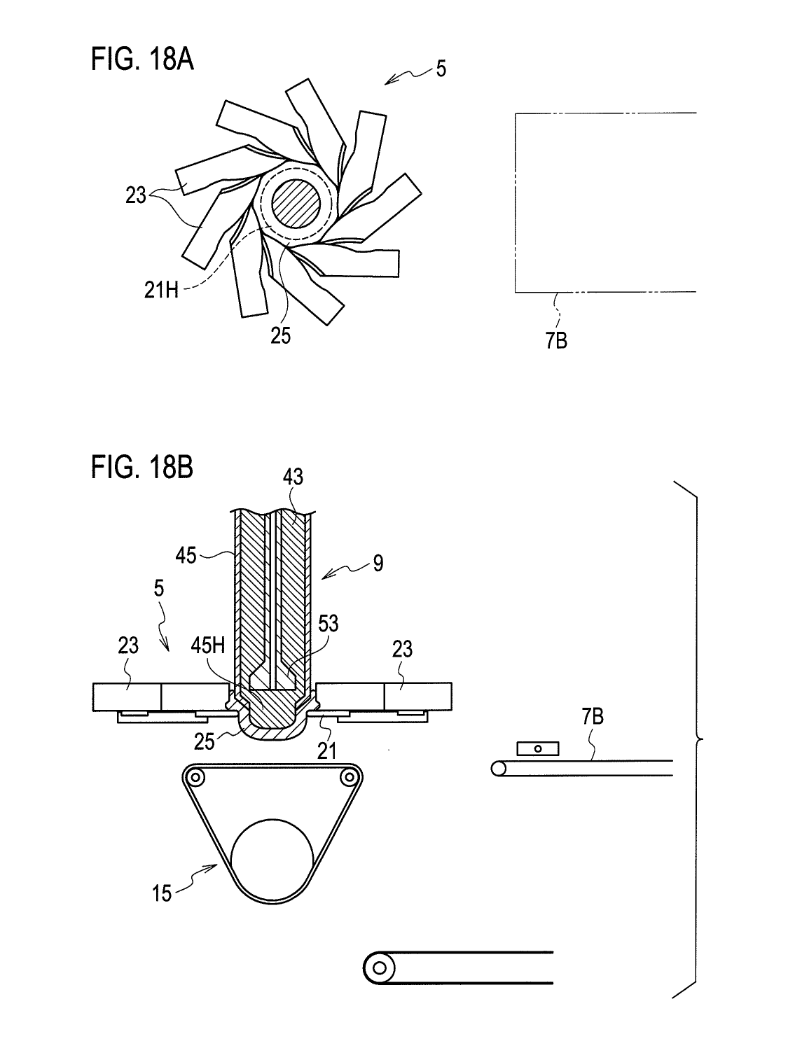

Further referring to FIGS. 18A, 18B, the valve portion 53 is set at an elevated position by means of the plunger portion 51, and the filling 43 is, under pressure by the feeder device 13, expelled onto the dough 25. The amount of the filling 43 is properly regulated by means of the feeder device 13. The supporting device 15 then, as described above, gets elevated to a position adapted for supporting the dough 25.

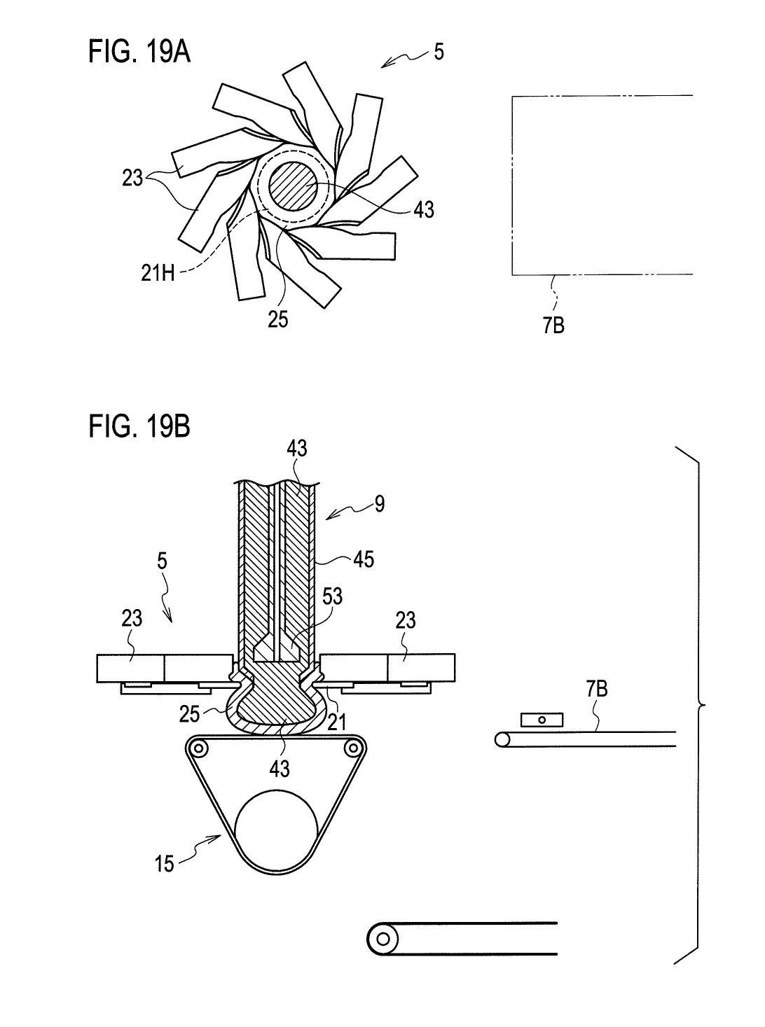

Further referring to FIGS. 19A, 19B, the filling 43 is expelled out and its weight makes the dough 25 further bulge downward. Then the dough 25 loaded with the filling 43 is supported from its lower side by the supporting device 15. The plunger 51 next lets the valve portion 53 down, thereby stuffing the dough 25 with a controlled amount of filling 43. The height of an upper face 43U of the filling 43 is then defined by a lower face of the valve member 53.

In this process, as the lower face of the dough 25 is supported by the supporting device 15, the part at issue hardly extends and therefore keeps its original thickness. As being stuffed with the filling 43, the dough 25 bulges radially. Thus mainly a portion ranging from the side to the periphery portion 25E is drawn out and made slightly thinner. Alternatively, during this process, the supporting device 15 may be made to gradually go down so as to regulate the degree of radial bulging.

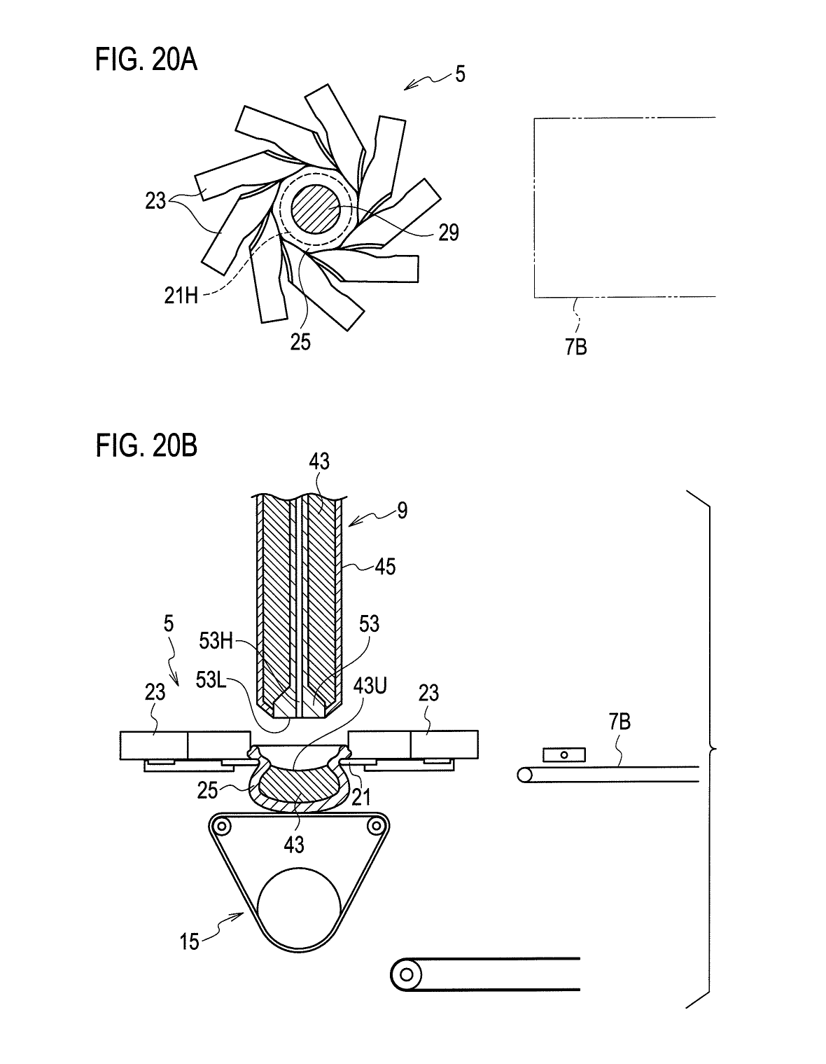

Next as shown in FIGS. 20A, 20B, the shutter device 5 and the supporting device 15 are made to go down together. Therefore the nozzle member 47 is detached from the filling 43 on the dough 25. The valve member 53 may be then elevated. If doing so, as inertial force acts on the filling 43 and on the other hand the valve member 53 gets elevated, separation of the filling 43 is promoted and as well shearing motion of the valve member 53 relative to the nozzle opening 45H also promotes separation of the filling 43. Further it may be executed to inject air through the through hole 53H. These actions are advantageous in preventing adhesion of the filling 43 to the valve member 53.

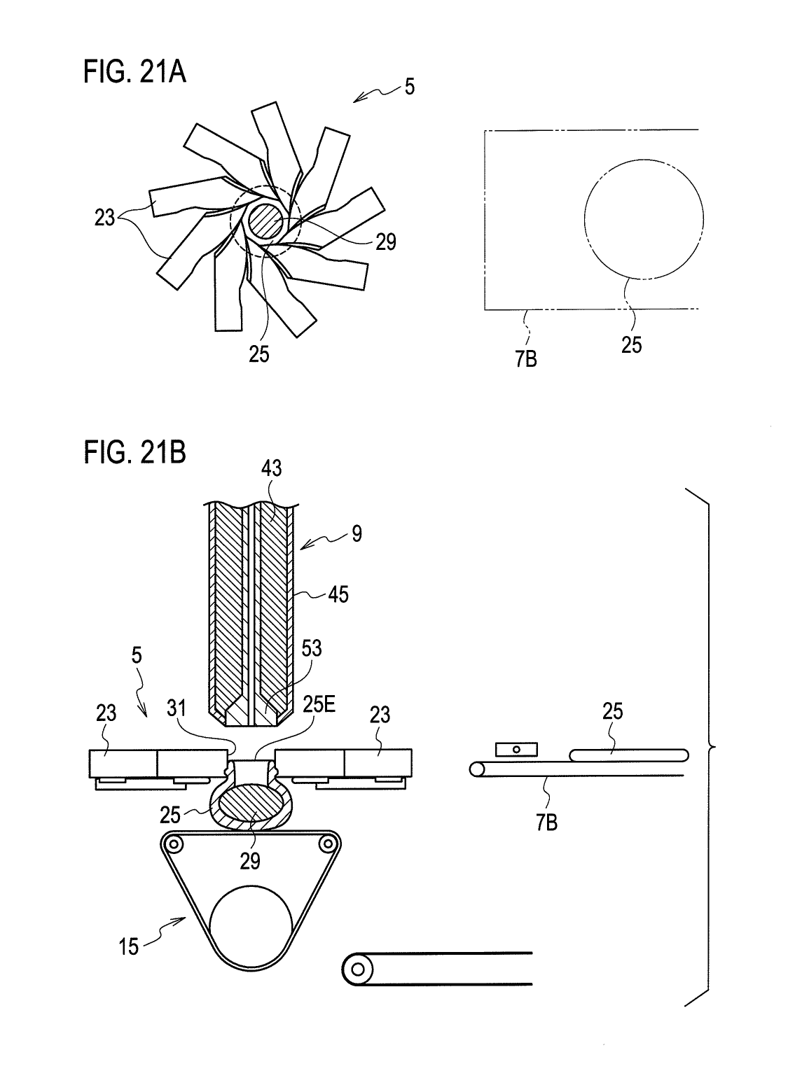

When the plurality of shutter pieces 23 is made to synchronously swing toward the center (the encircled region is narrowed) again as shown in FIGS. 21A, 21B, the periphery portion 25E of the dough 25 is further drawn out and gathered toward the center.

The height of the upper face 43U of the filling 43 has been in advance defined by the lower face of the valve member 53 and is lower than that of the periphery portion 25E of the dough 25 during gathering. Thus there is no concern that the filling 43 spills out during this process. Preferably the shutter device 5 and the supporting device 15 keep to go down.

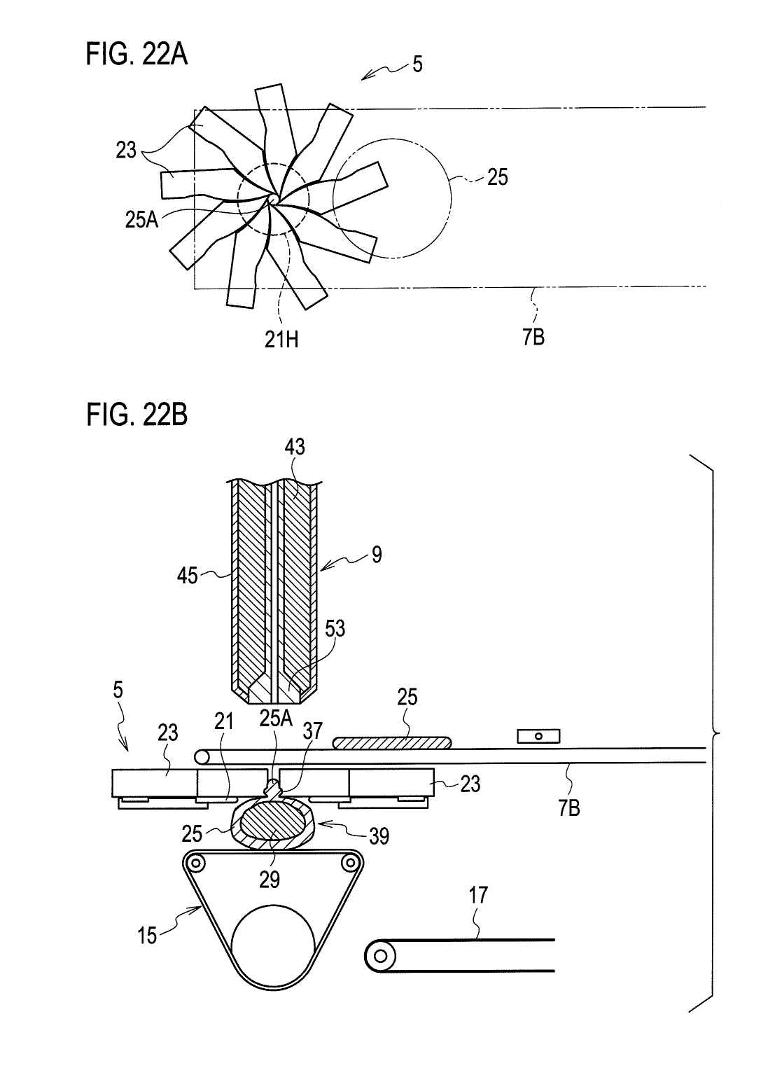

By further making the shutter pieces 23 swing, the periphery portion 25E of the dough 25 is thoroughly gathered as shown in FIGS. 22A, 22B, and is press-bonded at the sealing portion 25A. The filling 43 is covered with the dough 25 and then an encrusted food 55 is finished up. Then the second conveyor 7B is driven to transport next dough 25 onto the flange 21.

As with the embodiment described formerly, as the periphery portion 25E and its vicinities are gathered after thickness reduction, the upper portion of the crust does not come to be thick, and may be rather made thinner. Further the original size of the dough 25 can be in advance reduced in prospect of subsequent extension. The sealing portion 25A reflects the width of the supporting structure 35 and is therefore made to be relatively small. Further, as the shoulder portion 45T of the nozzle 9 has a shape adapted for pressing the periphery portion 25E outward, it is enabled that support of the periphery portion 25E is further assured and the upper portion of the crust is made further thinner.

As described above, various modifications will occur in regard to the linkage for setting the shutter pieces in synchronous motion. Instead of swing for example, translational motion may be applied as described below.

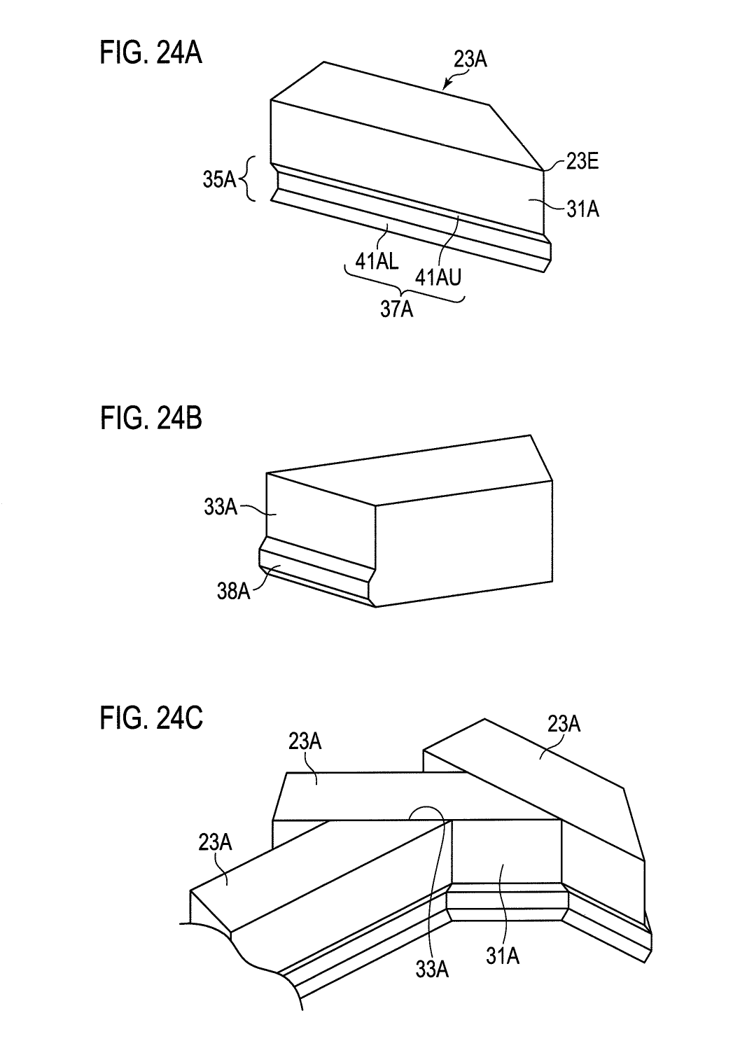

Referring to FIG. 24A and FIG. 24B, a shutter piece 23A is rectangular. Close to a lower edge of its pressure face 31A, and ranging from the tip end 23E to a proximal end of the pressure face 31A, provided is a structure 35A for supporting a periphery portion 25E of dough 25. The supporting structure 35 is comprised of a rake face 41AL standing upward from the lower edge of the pressure face 31A as with the aforementioned embodiment. The supporting structure 35A may be additionally comprised of an overhang face 41AU opposed to the rake face 41AL. The combination of the rake face 41AL and the overhang face 41AU constitutes a groove 37A.

An end of the shutter piece 23A is an obliquely cut-off relief face 33A. The pressure face 31A and the relief face 33A meets at the tip end 23E to form an acute angle. The relief face 33A may be additionally comprised of a rib 38A for slidably fitting in the groove 37A. Another end of the shutter piece 23A may be an oblique face or a face perpendicular to the main body. Further the lower face of the shutter piece 23A has a proper structure so as to slidably engage with the flange 21.

A plurality of shutter pieces 23A is as shown in FIG. 24C combined together so that a relief face 33A of one shutter piece 23A is in contact with a pressure face 31A of another shutter piece 23A. The groove 37A and the rib 38A, if provided, engage with each other. To retain contact between the relief face 33A and the pressure face 31A, any proper coupling member may be added.

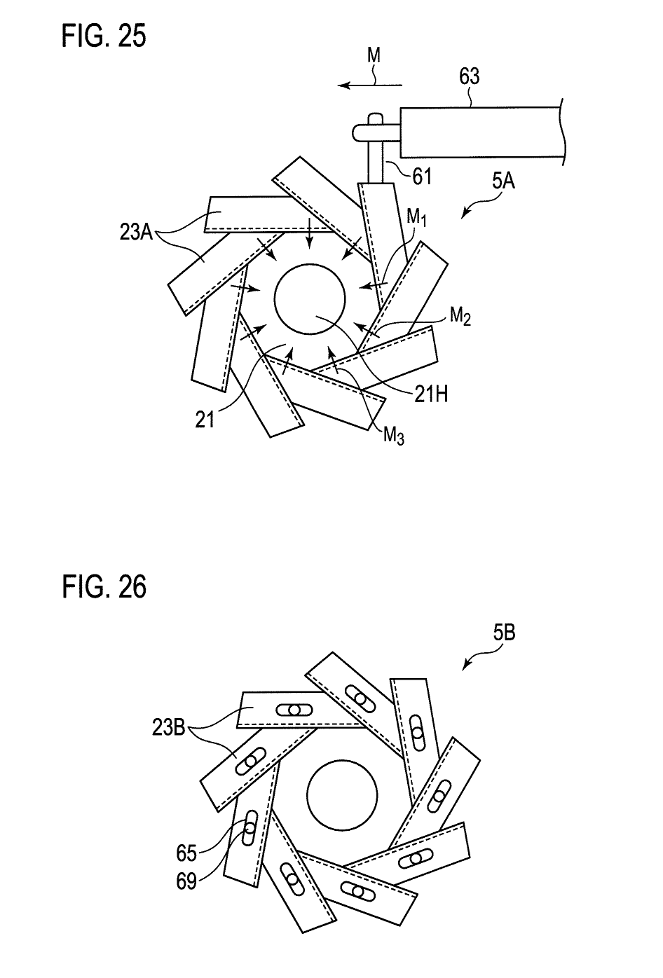

Thereby, as shown in FIG. 25, the plural shutter pieces 23A are mutually combined around the center to encircle the center and restrict each other to set each relief face 33A in slidable contact with each pressure face 31A. On one end of any shutter piece 23A provided is a plunger 61. If the plunger 61 is driven like as an arrow M by a cylinder 63, the shutter piece 23A at issue gets in motion like as an arrow M1 and its pressure face gets closer to the center. As the pressure face 31A obliquely gets in contact with the relief face 33A of the adjacent shutter piece 23A, the adjacent shutter piece 23A follows the motion of the shutter piece 23A at issue to get in motion like as an arrow M2. This shutter piece 23A further forces an adjacent shutter piece 23A toward an arrow M3. As such following motions sequentially occur, the plurality of shutter pieces 23A gets in synchronous motion, thereby respective pressure faces move toward the center (or get away from the center).

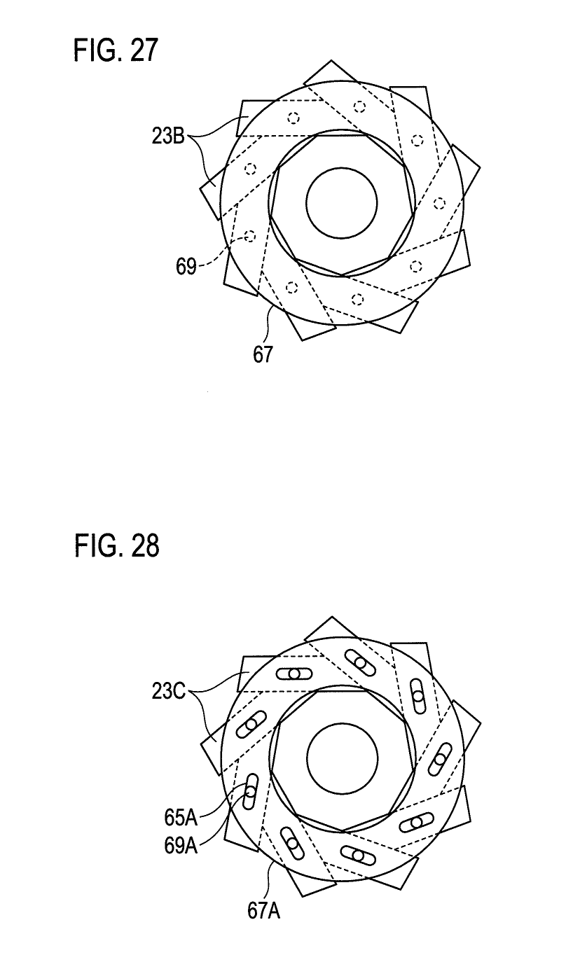

Alternatively, a modification as shown in FIG. 26 will occur. Each shutter piece 23B has a structure similar to that of any of the aforementioned embodiments and is further comprised of a slot 65 slidably fitting with a pin 69. A ring 67 having a plurality of pins 69 arranged along its circumference is as shown in FIG. 27 made to fit therewith. When the ring 67 is made to rotate around its center, the shutter pieces 23B synchronously get in motion, thereby respective pressure faces move toward the center (or get away from the center). Alternatively, as shown in FIG. 28, shutter pieces 23C may respectively have pins 69A and instead a ring 67A may have slots 65A.

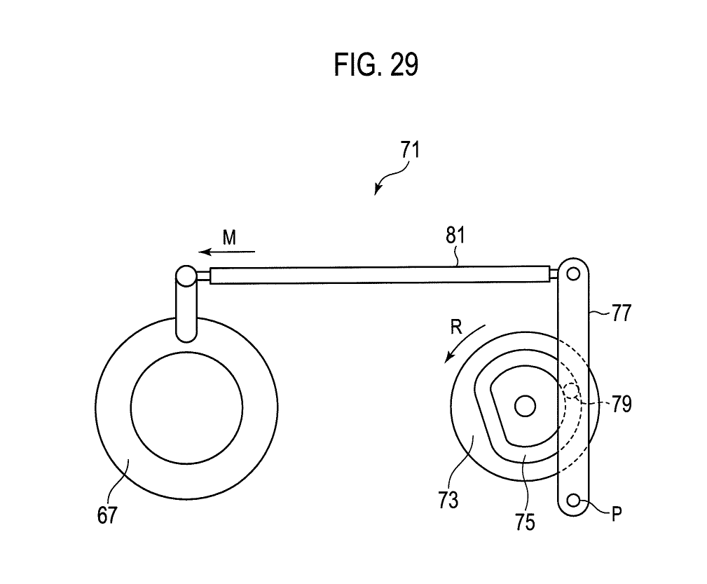

As described already, any driving means is applicable instead of a pneumatic or hydraulic cylinder. What is shown in FIG. 29 is an example thereof.

A driving means 71 is comprised of a disk 73 rotatable about its axis, an arm 77 pivotally supported by a pivot P, and a shaft 81 connected with the arm 77. The disk 73 is comprised of a proper groove 75 and the arm 77 is comprised of a follower 79 slidably engaging with the groove 75. When rotating the disk 73 like as an arrow R, the follower 79 moves along the groove 75 and this motion is transferred as a motion M through the arm 77 and a shaft 81. This motion M may be used for rotational motion of the link L and the ring 67 or for linear motion as shown in FIG. 25.

Although the invention has been described above by reference to certain embodiments of the invention, the invention is not limited to the embodiments described above. Modifications and variations of the embodiments described above will occur to those skilled in the art, in light of the above teachings.

### INDUSTRIAL APPLICABILITY

A production device and a production method which can make a top portion of a crust of an encrusted food to be relatively thin.

1. A shutter device for encrusting filling placed at a center with dough, comprising:
a plurality of shutter pieces arranged around the center so as to encircle the center, each of the shutter pieces having a pressure face facing to the center;
a linkage setting the plurality of shutter pieces in motion synchronously so as to direct the pressure faces toward the center; and
rake faces respectively formed on the pressure faces to stand upward from lower edges of the pressure faces and so dimensioned as to scoop up a periphery portion of the dough when the motion of the shutter pieces brings the rake faces into contact with the periphery portion.

2. The shutter device of claim 1, further comprising:
overhang faces respectively formed on the pressure faces so as to in combination with the rake face constitute a groove and so dimensioned as to press the scooped periphery portion into the groove by means of the motion, whereby the periphery portion is supported by the groove.

3. The shutter device of claim 2, wherein each of the shutter pieces comprises a relief face opposite to the pressure face, the relief face slidably engaging with the groove of the adjacent shutter piece.

4. The shutter device of claim 1, further comprising:
a plurality of pivots arranged along a circle around the center and respectively pivotally supporting the shutter pieces.

5. A production device applicable to production of an encrusted food in that filling is encrusted with dough, comprising:
a flange having an opening into which the dough loaded with the filling is capable of sinking down, the flange being so structured as to support the dough;
a conveyor configured to transport the dough onto the flange;
a nozzle configured to expel the filling onto the dough on the flange;
a plurality of shutter pieces disposed on the flange so as to be in contact with the flange and arranged around the center so as to encircle the center, each of the shutter pieces having a pressure face facing to the center;
a linkage setting the plurality of shutter pieces in motion synchronously so as to direct the pressure faces toward the center; and
rake faces respectively formed on the pressure faces to stand upward from lower edges of the pressure faces and so dimensioned as to scoop up a periphery portion of the dough when the motion of the shutter pieces brings the rake faces into contact with the periphery portion.

6. The production device of claim 5, further comprising:
overhang faces respectively formed on the pressure faces so as to in combination with the rake face constitute a groove and so dimensioned as to press the scooped periphery portion into the groove by means of the motion, whereby the periphery portion is supported by the groove.

7. The production device of claim 6, wherein each of the shutter pieces comprises a relief face opposite to the pressure face, the relief face slidably engaging with the groove of the adjacent shutter piece.

8. The production device of claim 5, wherein the nozzle comprises a shoulder portion so dimensioned as to catch the dough between the nozzle and one selected from the group consisting of a rim of the opening and the pressure faces of the shutter pieces.

9. The production device of claim 5, further comprising:
a plurality of pivots arranged along a circle around the center and respectively pivotally supporting the shutter pieces.

10. A method for encrusting filling placed at a center with dough, comprising:
arranging a plurality of shutter pieces around the center so as to encircle the center, each of the shutter pieces having a pressure face facing to the center;
setting the plurality of shutter pieces in motion synchronously so as to direct the pressure faces toward the center by means of a linkage;
bringing the pressure faces into contact with a periphery portion of the dough by means of the motion of the shutter pieces and scooping up a periphery portion of the dough by means of rake faces respectively formed on the pressure faces to stand upward from lower edges of the pressure faces; and
pressing the periphery portion by the pressure faces toward the center with making the rake faces support the periphery portion.

11. The method of claim 10, wherein the pressure faces respectively comprise overhang faces opposed to the rake faces so as to constitute grooves, further comprising:
pressing the scooped periphery portion into the groove to make the groove support the periphery portion.

12. A production method applicable to production of an encrusted food in that filling is encrusted with dough, comprising:
disposing a plurality of shutter pieces on a flange having an opening into which the dough loaded with the filling is capable of sinking down so as to be in contact with the flange;
arranging the plurality of shutter pieces around the center of the flange so as to encircle the center, each of the shutter pieces having a pressure face facing to the center;
transporting the dough onto the flange;
setting the plurality of shutter pieces in motion synchronously so as to direct the pressure faces toward the center by means of a linkage;
bringing the pressure faces into contact with a periphery portion of the dough by means of the motion of the shutter pieces and scooping up a periphery portion of the dough by means of rake faces respectively formed on the pressure faces to stand upward from lower edges of the pressure faces;
expelling the filling onto the dough on the flange through a nozzle;
making the dough loaded with the filling sink down into the opening; and
pressing the periphery portion by the pressure faces toward the center with making the rake faces support the periphery portion.

13. The production method of claim 12, wherein the pressure faces respectively comprise overhang faces opposed to the rake faces so as to constitute grooves, further comprising:
pressing the scooped periphery portion into the groove to make the groove support the periphery portion.

14. The production method of claim 12, further comprising:
catching the dough between a shoulder portion of the nozzle and one selected from the group consisting of a rim of the opening and the pressure faces of the shutter pieces.
